(19) United States
(12) Patent Application Publication
(10) Pub. No.: US 2023/0308273 A1
(43) Pub. Date: Sep. 28, 2023

(54) METHOD FOR TRANSMITTING AND RECEIVING METER DATA AND DEVICES IMPLEMENTING SAID METHODS

(71) Applicant: SAGEMCOM ENERGY & TELECOM SAS, Rueil Malmaison (FR)

(72) Inventors: Henri TEBOULLE, Rueil Malmaison (FR); Jean-Paul LECAPPON, Rueil Malmaison (FR)

(73) Assignee: SAGEMCOM ENERGY & TELECOM SAS, Rueil Malmaison (FR)

(21) Appl. No.: 18/168,094

(22) Filed: Feb. 13, 2023

(30) Foreign Application Priority Data
Mar. 24, 2022 (FR) 2202602

(51) Int. Cl. H04L 9/08; H04Q 9/00; H04L 9/06

(52) U.S. Cl. CPC H04L 9/088; H04Q 9/00; H04L 9/0643; H04Q 2209/60; H04Q 2209/40; H04Q 2209/50

(57) ABSTRACT

A method for transmitting meter data by a meter to a mobile device, the method including the following steps performed by the meter: receiving a request demanding meter data; obtaining meter data; generating a hashcode from at least one data pair including a serial number of the meter and the meter data obtained; encrypting the hashcode with a private key known solely to the meter, the encrypted hashcode being a signature; and transmitting to the mobile device, a frame including the meter data obtained and the signature.

### TECHNICAL FIELD

At least one embodiment relates to a method for transmitting meter data to a mobile device. At least one other embodiment relates to a method for receiving meter data.

Devices implementing said transmission and reception methods are also described.

### PRIOR ART

Smart meters are known, of the electricity meter, thermal-energy meter or fluid, e.g. gas or water, meter type, which comprise communication interfaces enabling an automated management system to implement remote collection of meter data, e.g. consumption data. For example, these smart meters comprise one (or more) communication interface(s) of the PLC type (the acronym of “Power Line Communication”) and/or of the radio type. They then transmit the meter data by means of these communication interfaces, e.g. in the form of frames, for transfer of these consumption data, at regular intervals or not, to an information system processing them in a centralised manner. These consumption data are used by the information system in particular for operations of invoicing the consumer customer by a service provider.

These smart meters are generally equipped with display means of the LCD (“liquid crystal display”) screen type enabling a consumer to view various information such as for example current consumption data, a water temperature, etc. Thus, in the event of a dispute with the service provider, the consumer can, by a direct reading on a screen of the meter, check the value of the consumption data.

Such meters have several drawbacks. In particular, they are sometimes difficult for a consumer wishing to receive information relating to the current consumption to access. Moreover, the display means, in addition to being expensive, are sensitive to external moisture and may pose problems of watertightness.

It is desirable to overcome these various drawbacks of the prior art. It is in particular desirable for the consumer to be able to access the meter data easily, and this in a secure manner, while limiting the problems of impermeability to external moisture.

### DISCLOSURE OF THE INVENTION

At least one embodiment relates to a method for transmitting meter data by a meter to a mobile device. The method comprises the following steps performed by said meter:
receiving a request demanding meter data;
obtaining meter data;
generating a hashcode from at least one data pair comprising a serial number of said meter and said meter data obtained;
encrypting said hashcode with a private key known solely to the meter, said encrypted hashcode being a signature; and
transmitting, to said mobile device, a frame comprising said meter data obtained and said signature.

The method described enables a consumer to easily access the meter data, and this in a secure manner. Moreover, this method makes it possible where applicable to dispense with display means on the meter and thus reduces the problems of impermeability.

According to a particular embodiment, generating a hashcode comprises applying a hash function to said data pair.

According to a particular embodiment, the hash function belongs to the set of hash functions comprising:
SHA-224 of the SHA-3 family;
SHA-256 of the SHA-3 family;
SHA-384 of the SHA-3 family;
SHA-512 of the SHA-3 family;
SHA-224 of the SHA-2 family;
SHA-256 of the SHA-2 family;
SHA-384 of the SHA-2 family;
SHA-512 of the SHA-2 family;
MD-4;
MD-5; and
SHA-1.

According to a particular embodiment, encrypting said hashcode with a private key known solely to the meter comprises applying an asymmetric elliptic curve encryption.

According to a particular embodiment, said meter data is data of an electricity meter, of a gas meter, of a thermal-energy meter or of a water meter.

At least one embodiment relates to a method for receiving meter data by a mobile device storing an application for reading a particular meter. The method comprises the following steps performed by said mobile device:
sending, to said particular meter, a request demanding meter data;
receiving a frame comprising meter data and a signature;
decrypting said signature with a public key associated with the particular meter;
generating a hashcode from a data pair comprising a serial number of said particular meter and said meter data received; and
comparing said decrypted signature and said hashcode generated and, in the case of equality, displaying said meter data on a screen of said mobile device and otherwise displaying an error message.

According to a particular embodiment, generating a hashcode comprises applying a hash function to said data pair.

According to a particular embodiment, the hash function belongs to the set of hash functions comprising:
SHA-224 of the SHA-3 family;
SHA-256 of the SHA-3 family;
SHA-384 of the SHA-3 family;
SHA-512 of the SHA-3 family;
SHA-224 of the SHA-2 family;
SHA-256 of the SHA-2 family;
SHA-384 of the SHA-2 family;
SHA-512 of the SHA-2 family;
MD-4;
MD-5; and
SHA-1.

According to a particular embodiment, said meter data is data of an electricity meter, of a gas meter, of a thermal-energy meter or of a water meter.

A meter configured for transmitting meter data to a mobile device is also described. The meter comprises:
means for receiving a request demanding meter data;
means for obtaining meter data;
means for generating a hashcode from at least one data pair comprising a serial number of said meter and said meter data obtained;
means for encrypting said hashcode with a private key known solely to the meter, said encrypted hashcode being a signature; and
means for transmitting, to said mobile device, a frame comprising said meter data obtained and said signature.

A mobile device configured for receiving meter data is also described. The mobile device stores an application for reading a particular meter and comprises:
means for sending, to said particular meter, a request demanding meter data;
means for receiving a frame comprising meter data and a signature;
means for decrypting said signature with a public key associated with the particular meter;
means for generating a hashcode from a data pair comprising a serial number of said particular meter and said meter data received; and
means for comparing said decrypted signature and said hashcode generated and, in the case of equality, displaying said meter data on a screen of said mobile device and otherwise displaying an error message.

At least one embodiment relates to a computer program product comprising instructions for implementing the transmission method or the reception method according to any one of the embodiments described previously, when said program is executed by a processor.

At least one embodiment relates to a storage medium storing a computer program comprising instructions for implementing the transmission method or the reception method according to any one of the embodiments described previously, when said program is executed by a processor.

### BRIEF DESCRIPTION OF THE DRAWINGS

The features of the invention mentioned above, as well as others, will emerge more clearly from the reading of the following description of an example embodiment, said description being made in relation to the accompanying drawings, among which:

FIG. 1 illustrates schematically a meter reading system according to a particular embodiment;

FIG. 2 illustrates schematically an example of hardware architecture of a smart meter according to a particular embodiment;

FIG. 3 illustrates schematically an example of hardware architecture of a mobile device configured for the local reading of meter data according to a particular embodiment;

FIG. 4 illustrates a method for transmitting meter data to a mobile device according to a particular embodiment; and

FIG. 5 illustrates a method for receiving meter data by a mobile device according to a particular embodiment.

### DETAILED DISCLOSURE OF EMBODIMENTS

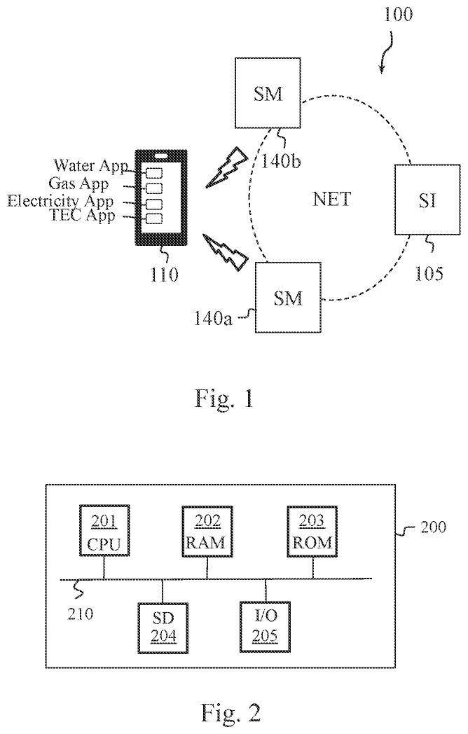

FIG. 1 thus illustrates schematically a meter reading system 100 wherein the various embodiments can be implemented. The meter reading system 100 is configured for making a reading of meter data, in particular of consumption data, from smart meters SM 140a and 140b. The smart meters SM 140a and 140b are for example electricity meters, gas meters, thermal-energy meters or water meters or of any other type of fluid, e.g. petrol, the consumption of which can be measured by means of metrology software. These smart meters 140a and 140b have the ability to communicate by radio and/or PLC transmission with an information system SI 105 either directly or by means of data concentrators, not shown on FIG. 1. The role of the information system SI 105 is to monitor the measuring operations performed by the smart meters SM 140a and 140b. The information system SI 105 comprises a head-end system HES, a meter data management system MDMS and a key management system KMS.

The smart meters 140a and 140b furthermore have the ability to communicate by NFC (the English acronym of “Near Field Communication”) or Bluetooth, e.g. 2.4 GHz BLE (the English acronym of “Bluetooth Low Energy”) radio transmission, with a mobile device 110 such as a smartphone or a tablet. The mobile device 110 is in particular configured for locally reading meter data and for displaying on its screen the meter data thus read after having checked that they do indeed come from the meter from which they are supposed to come. The meter data read locally by the mobile device are for example consumption data, effective voltage (Urms) and current (Irms) values for electricity meters, a water temperature and upstream and downstream pressure data for water meters.

For this purpose, the mobile device 110 comprises in memory an application for reading the meter. In a particular embodiment, the mobile device 110 comprises one application per type of meter for which the user is able to read the data. For example, as illustrated on FIG. 1, the mobile device 110 comprises four applications: an application denoted “Electricity App” for reading the electricity meter, an application denoted “Water App” for reading the water meter, an application denoted “Gas App” for reading the gas meter and an application denoted “TEC App” for reading the thermal energy or heat meter. Each application stores in memory the serial number of the meter for which the user is able to read the meter data as well as a public key associated with said meter.

When the data exchanges between the meter 140a or 140b and the mobile device 110 take place by NFC radio transmission, the mobile device 110 must be positioned at no more than 10 cm from the meter with which it wishes to communicate. The electricity meter being supplied all the time, its NFC function is activated permanently. On the other hand, the NFC function of water, gas and TEC meters that are supplied by cells or batteries is deactivated in normal times. Consequently, once the dedicated application is launched, the mobile device 110 seeks to establish an NFC link with the particular meter. The NFC interface of the particular meter then detects an activity on its radio interface and causes the awakening of the meter and therefore of its NFC function in the case of a water, gas or TEC meter.

When the data exchanges between the meter 140a or 140b and the mobile device 110 take place by Bluetooth radio transmission, the meters supplied by cells or batteries, i.e. water, gas and TEC meters, are awakened at the moment when the user wishes to read data. For this purpose, a long pressing (for example a pressing for a duration greater than 2 s) on the button located on the front face of the meter awakens it. It should be noted that the electricity meter does not comprise such a button since it is supplied by the mains. Its Bluetooth function is therefore activated permanently.

Thus the pairing between the meter 140a or 140b and the mobile device 110 is done by a long pressing on the button of the meter (in the case of a water, gas or heat meter), which then activates the Bluetooth on said meter, and moreover by a confirmation of the pairing with the meter that is identified by a name (incorporating its serial number typically) on a dedicated menu displayed on a screen of the mobile device 110.

In the case of the electricity meter, the Bluetooth always being activated, the pairing process can be done unilaterally on the mobile device 110 by a confirmation of the pairing with the electricity meter that is identified by a name (incorporating its serial number typically) on a dedicated menu displayed on a screen of the mobile device 110.

FIG. 2 illustrates schematically an example of hardware architecture of a smart meter 200 according to a particular embodiment.

The smart meter 200 comprises, connected by a communication bus 210: a processor or CPU (central processing unit) 201; a random access memory RAM 202; a read only memory ROM 203, for example a flash memory; a data storage device, such as a hard disk HDD (hard disk drive) or a storage medium reader, such as an SD (Secure Digital) card reader 204; at least one input-output interface I/O 205, in particular an interface for communication with the communication network NET, and at least one Bluetooth and/or NFC radio interface. The smart meter 200 may comprise a button on the front face, which is used for example for pairing said meter 200 with a mobile device.

The processor 201 is capable of executing instructions loaded in the RAM 202 from the ROM 203, from an external memory (not shown), from a storage medium, such as an SD card, or from a communication network (not shown). When the smart meter 200 is powered up, the processor 201 is capable of reading instructions from the RAM 202 and executing them. These instructions form a computer program causing the implementation, by the processor 201, of the steps and methods described below in relation to FIG. 4.

All or some of the steps and methods described below in relation to FIG. 4 can thus be implemented in software form by executing a set of instructions by a programmable machine, such as a DSP (digital signal processor) or a microcontroller, or be implemented in hardware form by a machine or a dedicated component (a chip) or a dedicated set of components (a chipset), such as an FPGA (field-programmable gate array) or an ASIC (application-specific integrated circuit). In general terms, the smart meter 200 comprises electronic circuitry arranged and configured for implementing the steps and method described below in relation to FIG. 4.

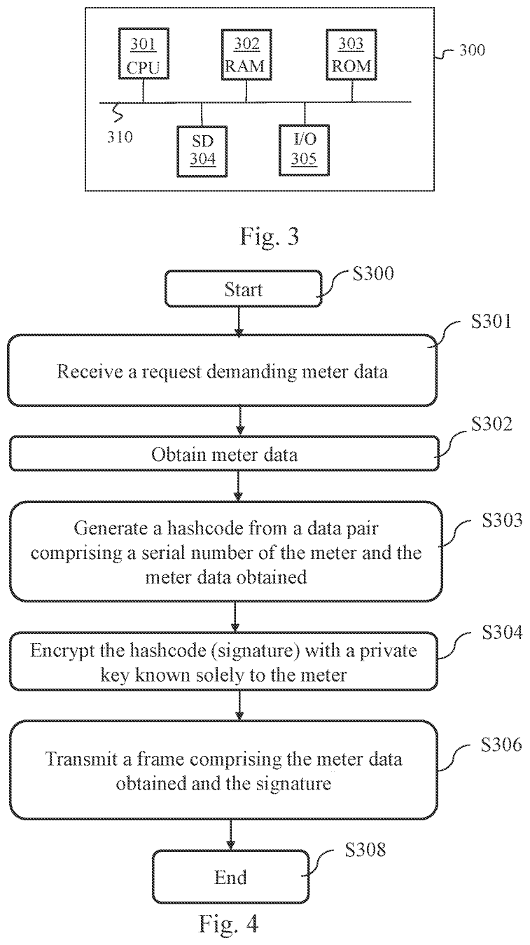

FIG. 3 illustrates schematically an example of hardware architecture of a mobile device 300 configured for locally reading meter data according to a particular embodiment.

The mobile device 300 comprises, connected by a communication bus 310: a processor or CPU (central processing unit) 301; a random access memory RAM 302; a read only memory ROM 303, for example a flash memory; a data storage device, such as a hard disk HDD (hard disk drive) or a storage medium reader, such as an SD (Secure Digital) card reader 304; at least one input-output interface I/O 305 that comprises in particular an interface for communication with the communication network NET, and at least one Bluetooth and/or NFC radio interface. The mobile device 300 furthermore comprises a screen on which meter data can be displayed.

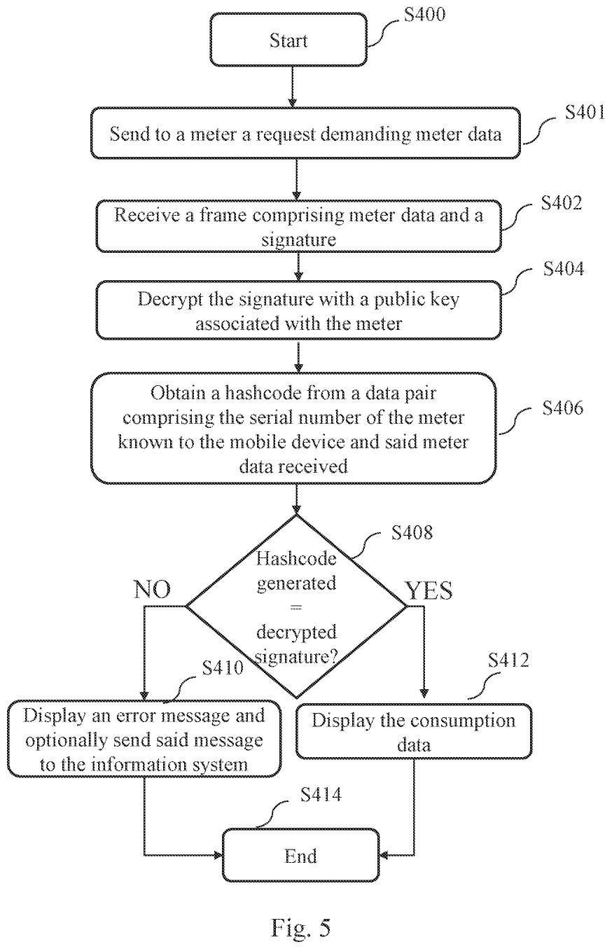

The processor 301 is capable of executing instructions loaded in the RAM 302 from the ROM 303, from an external memory (not shown), from a storage medium, such as an SD card, or from a communication network (not shown). When the mobile device 300 is powered up, the processor 301 is capable of reading instructions from the RAM 302 and executing them. These instructions form a computer program causing the implementation, by the processor 301, of the steps and methods described below in relation to FIG. 5.

All or some of the steps and methods described below in relation to FIG. 5 can thus be implemented in software form by executing a set of instructions by a programmable machine, such as a DSP (digital signal processor) or a microcontroller, or be implemented in hardware form by a machine or a dedicated component (a chip) or a dedicated set of components (chipset), such as an FPGA (field-programmable gate array) or an ASIC (application-specific integrated circuit). In general terms, the mobile device 300 comprises electronic circuitry arranged and configured for implementing the steps and method described below in relation to FIG. 5.

FIG. 4 illustrates a method for transmitting meter data by a meter according to a particular embodiment. The meter data is for example a metrological index representing consumption data of an electricity, water, gas or thermal-energy meter or a water temperature, a water pressure value, etc.

The method starts in a step S300.

In a step S301, the meter receives a request demanding meter data coming from the mobile device 110.

In a step S302, the meter obtains meter data, e.g. a metrological index via certified metrology software.

In a step S303, the certified software of the meter generates a hashcode denoted HASH from a data pair comprising the serial number of the meter and the meter data obtained. For this purpose, a hash function is used, e.g. a function in the SHA-2 family. The term hash function H(·) is given to a particular function which, from data supplied as an input, calculates a numerical hashcode serving to quickly identify the initial data. In other words, a unique hashcode, i.e. the result of the hash function, corresponds to a given pair. Consequently, for two different pairs T1 and T2, the meter generates two hashcodes S1=H(T1) and S2=H(T2) where S1 and S2 are different.

In one embodiment, the function H(·) is a function in the SHA-2 family, e.g. SHA-224, SHA-256, SHA-384 or SHA-512. In the case where the function H(·) is of the SHA-256 type, the hashcode obtained HASH comprises 256 bits. In the case where the function H is of the SHA-512 type, the hashcode obtained HASH comprises 512 bits. Other functions can be used, e.g. an SHA-3 function, an MD4 function, an MD5 function, an SHA-1 function, all well known in the cryptography field; these examples obviously not being limitative.

In a variant embodiment, an optional padding step is applied to the data pair in order to obtain an integer number of bytes before applying the hash function H(·).

In a step S304, the certified software of the meter encrypts the hashcode generated with a private key known solely to the meter. The encrypted hashcode is a signature and is denoted HASH′. This private key was previously generated by the meter from its serial number. In a particular embodiment, the private key is generated by applying an “exclusive OR” operator between a random value of N bits particular to the meter and H(serial number), e.g. N=256, and HO is the SHA-256 function for obtaining a private key of 256 bits. A public key known in particular to the information system is associated with this private key. The encryption is an asymmetric encryption, e.g. of the elliptic curve or RSA type. Asymmetric encryption is a technique that uses two encryption keys: a public key and a private key. The public key is shared without restriction whereas the private key is known only to the meter that generated it. The public key associated with the private key of a meter is in particular known to the mobile device 110. Thus the meter uses its private key for encrypting the hashcode HASH in order to obtain a signature HASH′ that the destination, in this case the mobile device 110, can decrypt with the public key of the meter.

Using an elliptic curve encryption advantageously makes it possible to limit the size of the signature HASH′. This is because asymmetric encryption of the RSA type uses encryption keys of greater size, e.g. from 2028 to 8192 bits, than an asymmetric elliptic curve encryption that uses encryption keys typically of size 256 to 384 bits. The size of HASH′ depends firstly on the size of HASH and secondly on the size of the private key of the meter. Thus, when the hashcode HASH and the private key of the meter are each in 256 bits, the size of the signature HASH′ is 512 bits. When HASH and the private key of the meter are each in 384 bits, the size of HASH′ is 768 bits.

In a step S306, the meter transmits a frame T comprising, in its payload, the signature HASH′ and the meter data. The frame is transmitted to the mobile device 110 in accordance with the selected communication protocol NFC or Bluetooth.

The method ends at a step S308.

This method is particularly advantageous since the meter data is transmitted to the mobile device 110 for reading on a screen of said mobile device and therefore makes it possible to dispense with screens on the meters. Moreover, this method makes it possible to easily access meter data even in the case where the meter is difficult to access.

FIG. 5 illustrates a method for receiving meter data coming from a meter by a mobile device 110 on which an application is stored for reading a particular meter, e.g. Water App in FIG. 1 for reading a water meter, according to a particular embodiment. The method is implemented in the mobile device 110.

The reading application knows in advance the following information that was supplied to it by the information system and/or locally: a serial number of the particular meter associated with the application and a signature public key of the particular meter.

When an operator downloads new metrology software or a new version of said software into a meter, the private and public signature keys are preserved. In a variant, said private and public signature keys are modified. In this case, the mobile device automatically recovers the new public key from the operator via the dedicated application, e.g. Water App on FIG. 1. The new public key is signed by the meter with its new private key and the whole is re-signed with the old private key of the meter so as to certify that the new public key does indeed come from the correct meter, said new public key being for its part transmitted in clear to the KMS. The KMS can then supply the new public key of the meter to the application.

The method starts in a step S400. It is supposed in general terms that the meter is awakened and able to exchange data with the mobile device. It is supposed in particular that the meter and the mobile device are paired if the transmissions take place by Bluetooth radio communication.

In a step S401, the mobile device 110 sends to a meter a request demanding meter data. If after a certain time t, e.g. t=30 seconds, no frame T is received coming from the meter, the mobile device 110 re-sends the request.

In a step S402, the mobile device 110 receives a frame T comprising in its payload a signature HASH′ and meter data.

In a step S404, the mobile device 110 decrypts said signature HASH′ with a public key associated with the meter identified by its serial number. This is because the dedicated application, e.g. Water App on FIG. 1, has the signature public key of the meter associated with the application the serial number of which is known to the mobile device. This public key is used for decrypting the received signature HASH′ and thus for obtaining a hashcode.

In a step S406, the mobile device 110 generates a hashcode HASH″ from the data pair comprising the serial number of the meter that it knows via the dedicated application and the payload received. In other words, the mobile device 110 performs the same operation as the meter at the step S303 with the data, i.e. serial number of the meter and meter data received, that it has available. In particular, the mobile device 110 uses, at the step S406, the same HASH function as the one used at the step S303 by the meter.

In a step S408, the mobile device 110 compares the hashcode HASH″ generated at the step S406 with the hashcode that is the result of the decryption of the signature HASH′ at the step S404. In the case of equality the method continues at the step S412. This is because, in the case of equality, the mobile device 110 is certain that the meter data present in the payload of the frame T does indeed come from the correct meter, i.e. from the meter supposed to have sent said meter data. It therefore displays said meter data on its screen. Then the method ends at a step S414.

In the case of inequality the method continues at the step S410.

At the step S410, the mobile device 110 displays an error message and optionally sends the error message or an alarm signal to the information system SI to indicate that the meter data received is posing a problem since it does not come from the meter from which it is supposed to come.

The method ends at a step S414.

1. A method for transmitting meter data by a meter to a mobile device, wherein the method causes the meter to perform:
receiving a request demanding meter data;
obtaining meter data;
generating a hashcode from at least one data pair comprising a serial number of the meter and the meter data obtained;
encrypting the hashcode with a private key known solely to the meter, the encrypted hashcode being a signature; and
transmitting, to the mobile device, a frame comprising the meter data obtained and the signature.

2. The transmission method according to claim 1, wherein generating a hashcode comprises applying a hash function to the data pair.

3. The transmission method according to claim 2, wherein the hash function belongs to the set of hash functions comprising:
SHA-224 of the SHA-3 family;
SHA-256 of the SHA-3 family;
SHA-384 of the SHA-3 family;
SHA-512 of the SHA-3 family;
SHA-224 of the SHA-2 family;
SHA-256 of the SHA-2 family;
SHA-384 of the SHA-2 family;
SHA-512 of the SHA-2 family;
MD-4;
MD-5; and
SHA-1.

4. The transmission method according to claim 1, wherein encrypting the hashcode with a private key known solely to the meter comprises applying an asymmetric elliptic curve encryption.

5. The transmission method according to claim 1, wherein the meter data is data of an electricity meter, of a gas meter, of a thermal-energy meter or of a water meter.

6. A method for receiving meter data by a mobile device storing an application for reading a meter, wherein the method causes the mobile device to perform:
sending, to the meter, a request demanding meter data;
receiving a frame comprising meter data and a signature;
decrypting the signature with a public key associated with the meter;
generating a hashcode from a data pair comprising a serial number of the meter and the meter data received; and
comparing the decrypted signature and the hashcode generated and, in the case of equality, displaying the meter data on a screen of the mobile device and otherwise displaying an error message.

7. The reception method according to claim 6, wherein generating a hashcode comprises applying a hash function to the data pair.

8. The reception method according to claim 7, wherein the hash function belongs to the set of hash functions comprising:
SHA-224 of the SHA-3 family;
SHA-256 of the SHA-3 family;
SHA-384 of the SHA-3 family;
SHA-512 of the SHA-3 family;
SHA-224 of the SHA-2 family;
SHA-256 of the SHA-2 family;
SHA-384 of the SHA-2 family;
SHA-512 of the SHA-2 family;
MD-4;
MD-5; and
SHA-1.

9. The reception method according to claim 6, wherein the meter data is data of an electricity meter, of a gas meter, of a thermal-energy meter or of a water meter.

10. A meter configured for transmitting meter data to a mobile device, the meter comprising circuitry causing the meter to perform:
receiving a request demanding meter data;
obtaining meter data;
generating a hashcode from at least one data pair comprising a serial number of the meter and the meter data obtained;
encrypting the hashcode with a private key known solely to the meter, the encrypted hashcode being a signature; and
transmitting, to the mobile device, a frame comprising the meter data obtained and the signature.

11. A mobile device configured for receiving meter data, the mobile device storing an application for reading a meter and comprising circuitry causing the mobile device to perform:
sending, to the meter, a request demanding meter data;
receiving a frame comprising meter data and a signature;
decrypting the signature with a public key associated with the meter;
generating a hashcode from a data pair comprising a serial number of the meter and the meter data received; and
comparing the decrypted signature and the hashcode generated and, in the case of equality, displaying the meter data on a screen of the mobile device and otherwise displaying an error message.

12. A storage medium storing a computer program comprising instructions for implementing the transmission method or the reception method according to claim 1, when the program is executed by a processor.
